(19) United States
(12) Patent Application Publication
(10) Pub. No.: US 2014/0355718 A1
(43) Pub. Date: Dec. 4, 2014

(54) DEVICE FOR MODIFYING TRAJECTORIES

(71) Applicants: Junqing Guan, Aachen (DE); Renato Negra, Aachen (DE)

(72) Inventors: Junqing Guan, Aachen (DE); Renato Negra, Aachen (DE)

(73) Assignee: RWTH AACHEN, Aachen (DE)

(21) Appl. No.: 14/344,543

(22) PCT Filed: Sep. 12, 2012
(86) PCT No.: PCT/EP2012/067764

§ 371 Date: May 15, 2014

(30) Foreign Application Priority Data
Sep. 12, 2011 (DE) 10 2011 053 501.2

(51) Int. Cl. H04L 27/36

(52) U.S. Cl. CPC H04L 27/36
USPC 375/300

(57) ABSTRACT

The invention relates to a device for modifying trajectories.

The invention relates to a device for modifying trajectories.

Numerous data transmission systems use complexly modulated signals during data transmission. Particularly in the area of wireless communication, there is a trend toward devices that are designed to operate several transmission standards, for instance 3G and LTE or, in the future, 4G. One consequence of this trend is an increasing shift of transmission devices toward the digital side. On the other hand, however, it should be noted that the turn toward CMOS technologies as well as to technologies with structures of 65 nm and below have disadvantageous high-frequency characteristics.

These complexly modulated signals are first appropriately generated on the basis of an incoming DATA data signal and then amplified to the required signal level so that the amplified modulated signals can then be sent over a suitable wireless or wired transmission medium to the receiver. If a switch is made from one complex signal state to another complex signal state, the signal completes a trajectory.

The reason for the use of complexly modulated signals is their increased spectral efficiency. However, one characteristic of these modulation techniques is the very high peak-to-average power ratio (PAPR) of the signals. As a result, amplifiers must be provided for these transmission systems that have the necessary power reserve for the peak signals, whereas only average power is required most of the time. Typically, however, the efficiency of the amplifiers is substantially diminished in the partial load range.

However, this lower energy efficiency is disadvantageous, since energy is unnecessarily consumed and heat is unnecessarily produced. Both of these consequences are particularly negative in portable devices, since they impact the battery life while also requiring more efficient cooling means.

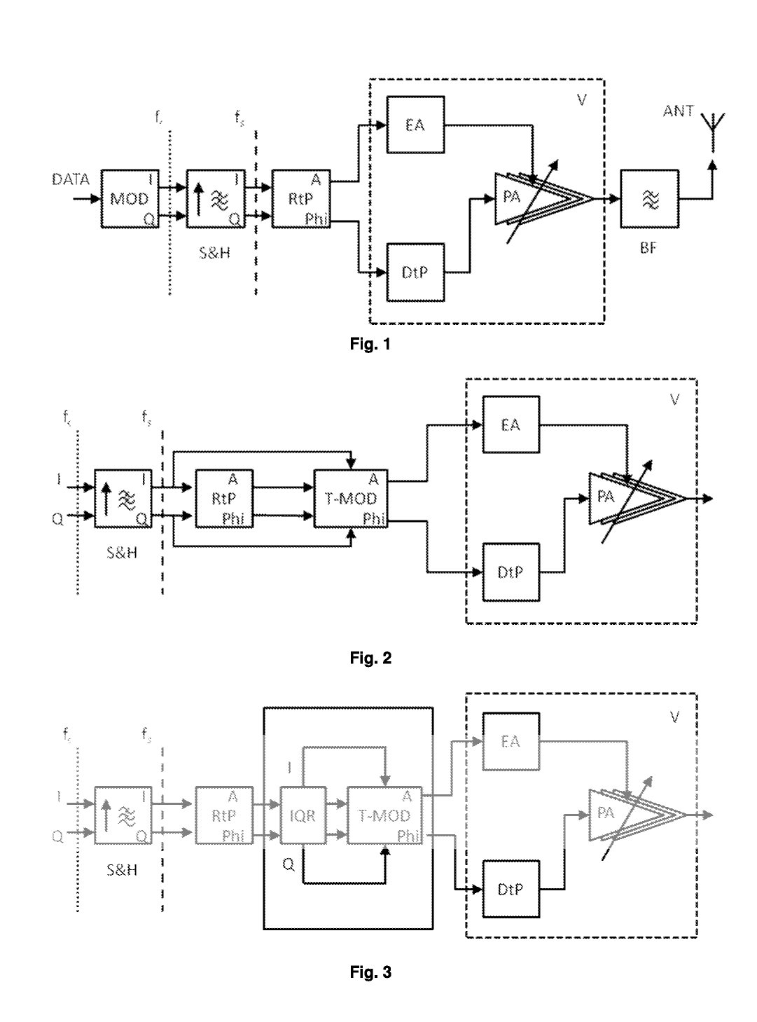

One possible way to provide a remedy for this while achieving a good level of efficiency with good linearity in the amplifier is the introduction of so-called polar technologies. In this kind of technology, of which FIG. 1 shows an example representation, the supply voltage of an amplifier V is modulated with a high-frequency envelope signal. In this process, the digital quadrature components I, Q of the complex signal are converted into their polar equivalent components A, Phi. The amplitude component A is amplified in an envelope amplifier and modulates the supply voltage of the amplifier stage V while the phase component Phi is converted in a digital-toRF phase converter DtP and used to modulate the carrier of the high-frequency signal, which is then made available to the amplifier V as an input signal. This arrangement enables the amplifier to work near or at saturation over substantial portions of time, thus improving energy efficiency.

It should be noted, however, that the conversion of quadrature components I, Q into the polar equivalent components A, Phi is non-linear. As a result, the bandwidth of the amplitude and of the phase is increased, by a factor of 4 to 10 for example. Consequently, the envelope amplifier and the phase converter must be able to process considerably greater bandwidths. For today's wireless transmission system standards, this would mean bandwidths of several hundred MHz. Such amplifiers would be both expensive and difficult to manufacture. Linearity over the entire bandwidth would pose a particular problem here.

It is also disadvantageous that linearity would be extremely low at low amplitudes in particular, since the phase-modulated carrier signal drifts at low amplitudes and hence low amplifier supply voltages.

Although it would in principle be conceivable to use a low amplitude and a quick phase change of the constellations as an indication of a crossing through the origin or an approach to the origin requiring correction and then to add a “correcting” offset vector to this, such a method would be quite crude and considerably more points would be detected than necessary, which would lead to pronounced distortions.

In principle, it would also be possible to use an amplitude-increasing circle-tangent-shift hole-punching algorithm in order to avoid a crossing within a predetermined circle around the origin on the basis of two successive constellations. However, this approach would not deal with the problem of the increased bandwidth of the phase change, nor would it yield results that would be able to meet even more stringent requirements on in-band distortions and out-of-band emissions. Since this approach requires repeated execution in most cases, it generally would not permit real-time processing and would require a large amount of processing power and memory.

It would also be possible to add a Gaussian-shaped signal or to use a Hanning window noise shaper in order to eliminate signals that lie below a certain threshold value, thus preventing spectral splatter. However, this is associated with grave in-band distortions that can render the actual signal unusable. What is more, this method is not suited to resolving the problems with quick phase changes and hence with the bandwidth of the phase signal.

It is therefore an object of the invention to provide a device and a method that remedy one or more of the drawbacks known from the prior art.

The object is achieved by a device for modifying trajectories for use in a transmitting device in a digital transmission device, with signals to be transmitted being complexly modulated and with a trajectory being produced when a change from a first signal state to a second signal state occurs. The device comprises a first input and a second input for receiving the components of the complex signal to be transmitted. Moreover, the device also has a first output for providing an amplitude component of a modified signal to be transmitted and a second output for providing a phase component of a modified signal to be transmitted, as well as a processing unit which provides modified components on the basis of the received components of the signal to be transmitted, with trajectories that pass near the origin or touch the origin being modified such that the modified trajectory passes by the origin at a greater distance.

Additional embodiments according to the invention constitute the subject matter of the dependent claims.

In the following, the invention will be explained in further detail with reference to the figures:

FIG. 1 shows a simplified block diagram of a polar transmitter from the prior art;

FIG. 2 shows a simplified block diagram of a polar transmitter with a first embodiment of the invention;

FIG. 3 shows a simplified block diagram of a polar transmitter with a second embodiment of the invention;

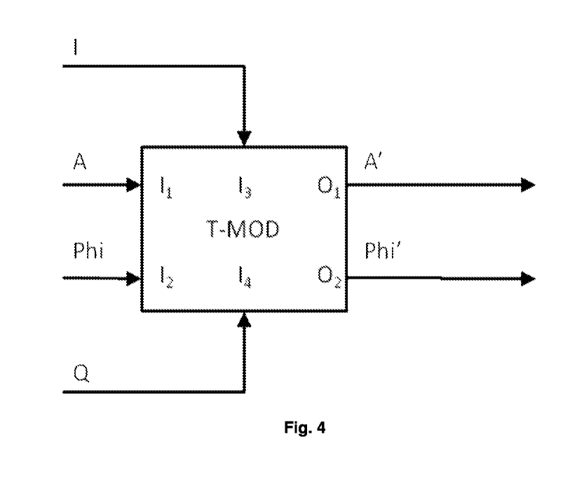

FIG. 4 shows a simplified block diagram of an aspect of the invention;

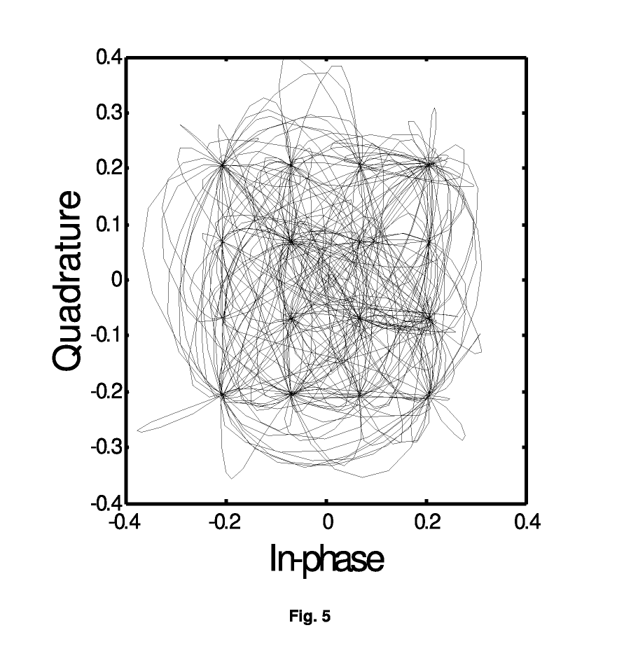

FIG. 5 shows a vector diagram of a signal;

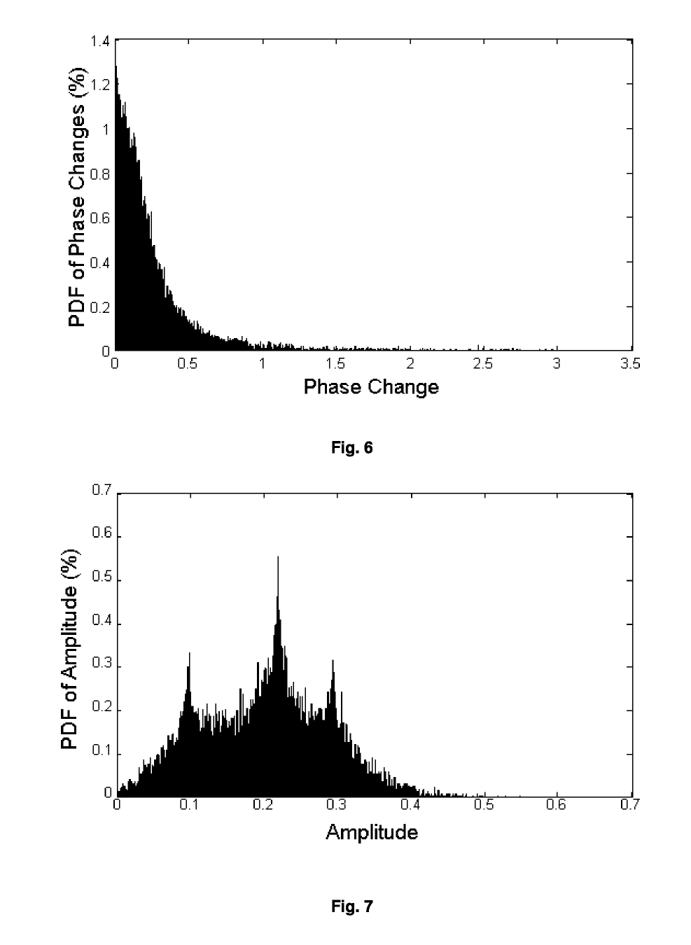

FIG. 6 shows phase transition statistics between 0 and π;

FIG. 7 shows signal amplitude statistics;

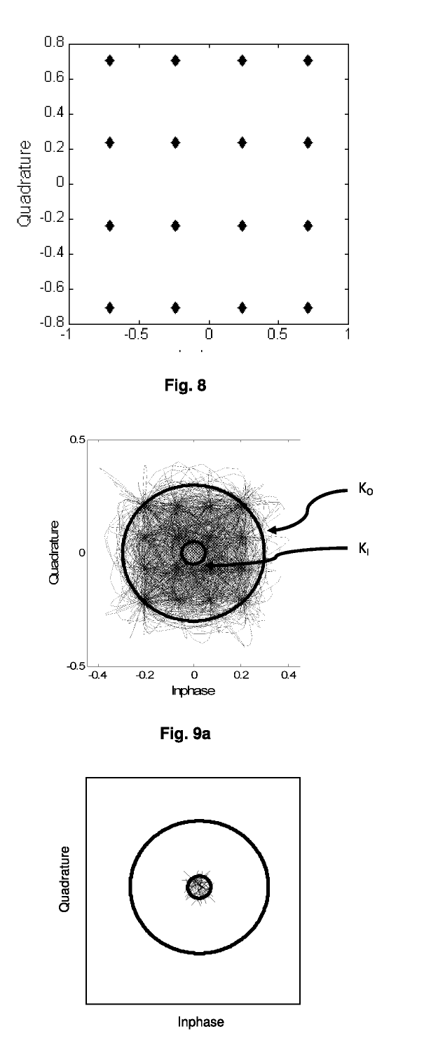

FIG. 8 shows constellations of a complex modulation;

FIGS. 9a, 9b show constellations of a complex modulation with signal trajectories;

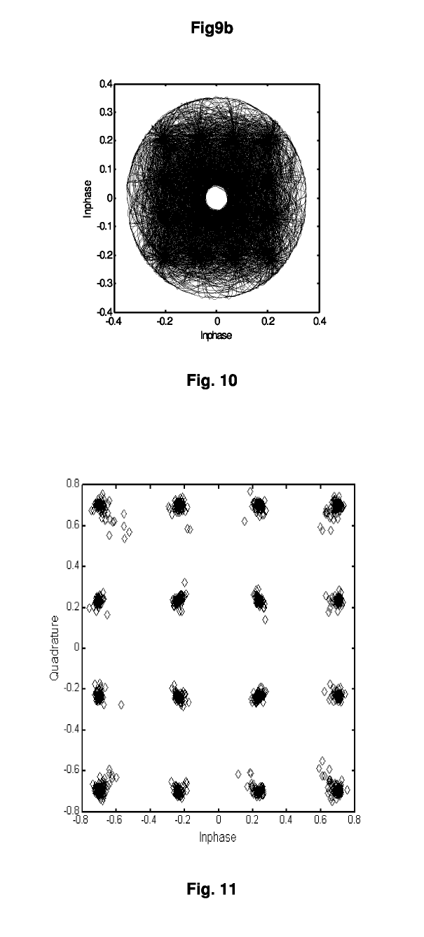

FIG. 10 shows example signal trajectories during use of the invention;

FIG. 11 shows example demodulated constellations during use of the invention;

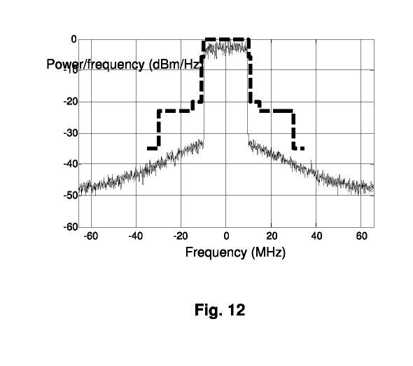

FIG. 12 shows a normalized power density spectrum mask for an LTE uplink at 20 MHz;

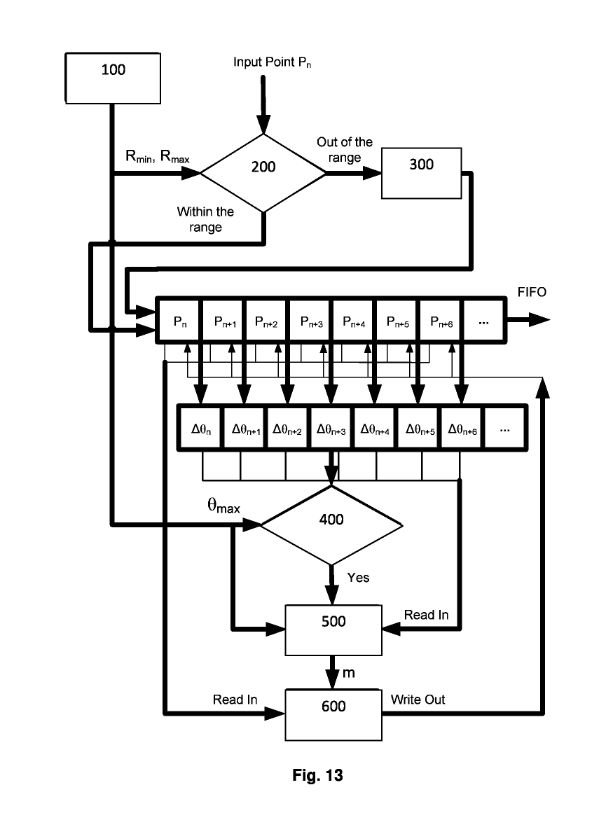

FIG. 13 shows a simplified flowchart according to one embodiment of the invention;

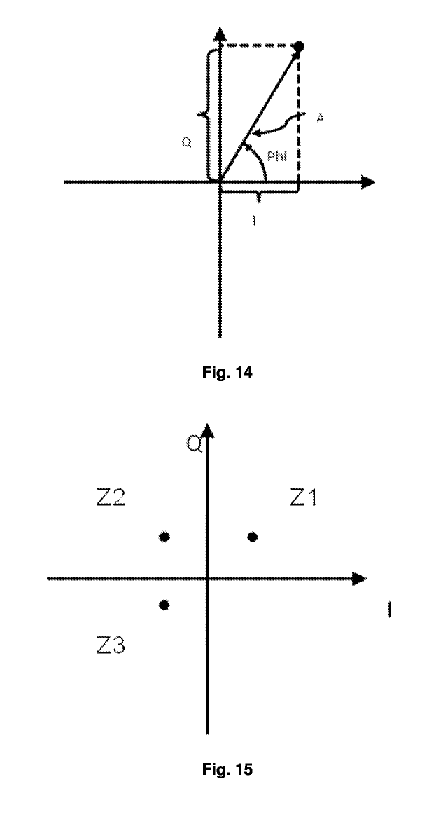

FIG. 14 shows the mathematical relationship between complex quadrature components and the polar representation, and

FIG. 15 shows three exemplary signal states/constellations.

FIG. 1 shows a simplified block diagram of a digital polar transmitter from the prior art. This receives an input signal DATA to be encoded, which is converted in a modulator MOD into complex signal components, an in-phase component I and a quadrature component Q. Usually, data DATA of a channel coder are processed which arrive at a certain chip rate f_{c} and are modulated in the modulator MOD. An interposed sample&hold device S&H scans the modulated signals I and Q, with low out-of-band noise being achieved by means of oversampling filtering at a scanning frequency fₛ. Then, the complex signals I, Q prepared in this way arrive at a converter RtP, which generates the corresponding polar coordinates A, Phi from the components I, Q. For the mathematical relationship between the two relationships, see FIG. 14. The amplitude component A is now fed to an envelope amplifier EA, while the phase components Phi are fed to a digital-to-HF phase converter DtP. Next, the amplifier PA, whose input voltage is made available by the envelope amplifier EA, amplifies the driving phase signal that is received from the digital-to-HF phase converter DtP. The now-amplified signal can then also be sent for band filtering in a band filter BF in order to limit spectral components outside of the actual usable band. The modulated high-frequency signal is then fed to an antenna ANT or to another suitable medium, for example, a cable.

FIG. 5 shows resulting trajectories of the modulated signal at a scanning frequency fₛ.

Numerous crossings through the origin or in the vicinity of the origin (near-zero crossings) can be observed here. These zero crossings or even near-zero crossings have both low amplitude and partially fast phase changes in the region of π (similar to a reflection at the origin in the polar representation). This is also illustrated for the sake of example using the symbols in FIG. 15. A change from signal state Z1 to signal state Z2 brings about no change in the low amplitude, and a change from signal state Z1 to signal state Z3 additionally results in a maximum phase change of π.

However, as already explained, low amplitudes result in poor linearity and low efficiency on the part of the amplifier PA, while the strong phase changes load the digital-to-HF converter DtP. In order to quantify the phase change, the frequency deviation

$$Δ f = \frac{Δθ}{2 πΔ {T}_{s}}$$

is used, where Θ stands here for the phase and Tₛ is derived from the scanning frequency fₛ. From this, it follows that the maximum frequency deviation should be max_{0≦Δθ≦π}Δf=fₛ/2.

In modern high-bit-rate data transmission systems, this maximum frequency deviation can be several hundred MHz. This results in the already-discussed difficulties with enabling modulation of the high-frequency oscillator within a scanning period with strict phase noise requirements and setting range.

FIG. 6 shows a probability density function (PDF) of phase changes between adjacent signal states, with phase changes between 0 and 2π being indicated. FIG. 7 shows a probability density function (PDF) of amplitude changes between adjacent signal states. Although, statistically speaking, fast phase changes and low amplitudes are statistically rather rare, it is not only these signal states that are distorted, but adjacent ones as well, so that the error vector magnitude (EVM) as well as the bit error rate (BER) become unacceptably large.

Next, FIG. 8 shows the original constellations but without consideration of any error vectors, which is to say that the representation shows only the signal states as they appear at the output of the modulator MOD. After further modulation in the example of a 20-MHz single carrier with OFDM modulation (OFDM—orthogonal frequency division multiplexing), such as is characteristic, for example, for an SCFDMA channel in an LTE uplink, one obtains the trajectories of a complex signal such as is shown in FIG. 9a. For the sake of clarity, two circles K_{I}, K_{O} are added here which are used to further explain the invention.

The outer circle K_{O} indicates a desirable maximum amplitude, which is such that the amplifier PA is still operating in the linear range and near and at saturation. The inner circle K_{I} indicates a desirable minimum amplitude, so the amplifier PA still operates in the linear range. In addition, FIG. 9b, which shows a section from FIG. 9a, also indicates signal states having a large phase change, this phase change lying over the indicated threshold Δθₘₐₓ. It can clearly be seen here that strong phase changes occur not only in the directly adjacent constellations, but also in more distant ones.

It is the object of the invention to modify the trajectories such that the modified trajectories are located between the inner circle K_{I} and the outer circle K_{O}, as a result of which the maximum phase change is limited and a minimum amplitude is also always available. In other words, the modified amplitudes are to be between [Rₘᵢₙ, Rₘₐₓ], where Rₘᵢₙ corresponds to the amplitude of the inner circle K_{I} and Rₘₐₓ corresponds to the amplitude of the outer circle K_{O}.

The inventive method and the inventive device being presented here for this purpose use the values Rₘᵢₙ, Rₘₐₓ, Δθₘₐₓ as boundary conditions and modify the points of a trajectory occurring at a certain scanning frequency fₛ into ones which meet the boundary conditions. The result of this modification is shown in FIG. 10. As can be seen there, all of the modified trajectories meet the boundary conditions with respect to amplitude, which is to say that all of the points of the modified trajectory have a radius that lies within [Rₘᵢₙ, Rₘₐₓ]. Generally speaking, one could characterize the inner circle as a hole, whereas the outer circle could be characterized as a bounding circle. Moreover, the inventive method and the inventive device being presented also eliminate the phase changes shown in FIG. 9b, which are greater than Δθₘₐₓ and would have therefore resulted in frequency deviations Δfₘₐₓ above the threshold value.

The modification of the trajectories on the basis of the boundary conditions also impacts the resulting EVM. A permissible EVM range is specified for each transmission system. Depending on that, the influence of the boundary conditions on the modification must be selected. For example, FIG. 11 shows the demodulated constellation diagram with an EVM of approximately 3.4%, so the permissible value of an LTE system of up to 8% is readily fulfilled. As a result, reserves are left for other components of the transmission system that also have an impact on the EVM.

FIG. 12, in turn, shows the normalized power spectrum density of the complex base band signal after trajectory modification. Here, the broken line shows the spectrum mask for an LTE uplink with a bandwidth of 20 MHz. As can clearly be seen, the out-of-band emission is also ensured by this method, since the corresponding power densities lie below the mask, and a reserve of about 10 dB is still available at an offset frequency of 10 MHz, and 5 dB is still available even at an offset frequency of 20 MHz. This reserve is left for other components of the transmission system, for example those which have an impact on the linearity.

Consequently, the invention is not something that alters the modulation schema as such, but rather is conceived to be able to be introduced into any system—even after the fact. Suitable systems are transmission systems that process complex-valued signals, such as, for example, PWPM, ΔΣ, LINC and polar transmitters. Moreover, the method is extremely flexible, so it can be introduced at a very wide range of processing stages at a very wide range of frequencies. The resulting EVM can be adapted through the appropriate selection of the boundary conditions.

The method will be further explained below. For that purpose, it will first be assumed that the signals to be modified are <p₁, p₂, p₃, . . . ,pₘ> and the boundary conditions are Rₘᵢₙ, Rₘₐₓ, ΔθₘₐₓAfter the modification, the signals are designated with <p′₁, p′₁, p′₃, . . . p′m>.

The modification is based on a criterion that provides for a minimum EVM in the best case:

$${min}_{〈 p {1}^{′} , p {2}^{′} , p {3}^{′} , … 〉} \sqrt{{\sum }_{n = 1}^{e} {( {p}_{n} - {p}_{n}^{′} )}^{2}}$$

By applying this criterion, distortions are minimized while boundary conditions are adhered to at the same time.

In order to reduce the complexity of this condition while ensuring real-time processing with low computational burden and high efficiency, and to minimize tradeoffs resulting from meeting the criterion, complexity can be reduced.

FIG. 13 shows a simplified flowchart for a trajectory modification according to one embodiment of the invention. First, in a step 100, the parameters are configured for Rₘᵢₙ, Rₘₐₓ, Δθₘₐₓ. Then the number of values for 2 or more signal points pₙ are obtained. The values are, for example, polar coordinates A, Phi. Each signal point is checked in step 300 [sic; apparent error for “200”-tr.] to see whether the amplitude is within the range Rₘᵢₙ, If not, the corresponding amplitude value is processed in a step 300, i.e., it is either raised to Rₘᵢₙ or lowered to Rₘₐₓ. The modified amplitude value is then transferred to a shift register FIFO. If the amplitude is within the range Rₘᵢₙ, Rₘₐₓ, then the amplitude value is transferred directly to the shift register FIFO. In addition, the respective phase values for the 2 or more signal points pₙ are read into the shift register FIFO.

As soon as phase values from two adjacent signal points are known, the phase change can be determined. This phase change can now be compared in a step 400 to see whether the maximum phase change Δθₘₐₓ has been exceeded or not. In the process, the phase change can also be determined on the basis of received in-phase and quadrature components I, Q. If the phase change is greater than a predetermined threshold, then signal points must be modified. For this, it is determined in a step 500 how many signal points have to be processed, i.e., how many successive signal points lead to a phase change over the limit. In consideration of the number m of points to be processed, the phase values are read out of the shift register and processed in a step 600, where a low to minimum EVM is guaranteed. Then the modified phase values are again read into the shift register at the corresponding location. The modified signal points which form a modified trajectory in this way can then be outputted. As is already clear, the number of signal points to be modified can differ, with an appropriately-sized shift register FIFO provided here. In other words, not just two adjacent signal points, but numerous ones can be used.

Since more than 2 adjacent signal points can be taken into account, distortions can be prevented in this way, since one phase change can now be distributed to a plurality of signal points. However, since no iterations of any kind are required, the method is fast and enables real-time processing.

The invention can be implemented, for example, in hardware or software or in a combination of hardware and software. Examples of hardware solutions are indicated in FIGS. 2 and 3.

There, for the device in FIG. 1, a device [is shown] for modifying trajectories T-MOD for use in a transmitting device in a digital transmission device, the signals to be transmitted being digitally and complexly modulated, and a trajectory occurring with a change from a first signal state to a second signal state.

This device for modifying trajectories T-MOD, which is also represented in FIG. 4, has a first input I₁ for receiving an amplitude component A of a signal to be transmitted and a second input I₂ for receiving a phase component Phi of the signal to be transmitted. Alternatively or in addition, one device for modifying trajectories T-MOD has a third and a fourth input I₃, I₄ for receiving quadrature components I, Q of the signal to be transmitted. In other words, the device has at least two inputs in order to receive a representation of a complex signal, i.e., in-phase component I and quadrature component Q or amplitude component A and phase component Phi. Without going into this any further at this point, the respective amplitude component A and phase component Phi can each be calculated from the in-phase component I and quadrature component Q and, conversely, the in-phase component I and quadrature component Q can be calculated, in turn, from each amplitude component A and phase component Phi. What is more, one device for modifying trajectories T-MOD has a first output O₁ for making available an amplitude component of a modified signal to be transmitted and a second output O₂ for making available a phase component of a modified signal to be transmitted, as well as a processing unit which, on the basis of the received components of the signal to be transmitted, makes modified components available, with trajectories that cross near the origin or touch the origin being modified such that the modified trajectory crosses at a greater distance from the origin.

On the basis of received amplitude components and phase components and/or received in-phase and quadrature components, one can decide whether a modification of trajectories is required.

In this way, it is possible for an appropriate device according to the invention to receive, for example, only the in-phase and the quadrature component I,Q as an input signal and to determine on the basis of the received component values that a modification must be made. The modification can then be made before a polar conversion into amplitude component A and phase component Phi or after the polar conversion into amplitude component and phase component.

On the other hand, it is also possible to receive only amplitude and phase components A, Phi as an input signal and then to determine on the basis of the received components that a modification is required, or first to perform a conversion to in-phase and quadrature component and then to determine the necessity of a modification on the basis of those components.

Frequently, however, both representations of the digital complex signal are available as an input signal, so the decision regarding the amplitude can be made in a quick and memory-saving manner on the basis of the received amplitude component A, while the phase condition can be carried out in a quick and memory-saving manner on the basis of the in-phase and quadrature component I,Q and while the actual modification is made, in turn, on the basis of the received amplitude and phase components A, Phi.

In a preferred embodiment of the invention, the trajectories are modified such that they do not touch a nearly circular region K_{I} around the origin. As a result, no drifting of the driving phase signal occurs, thus minimizing distortions.

Moreover, in a preferred embodiment of the invention, the processing unit is further set up such that trajectories that lead past the origin at a great distance are modified such that the modified trajectory passes at a closer distance from the origin. In addition, a preferred embodiment of the invention is designed such that the modified trajectories do not leave a nearly circular region around the origin. As a result, the trajectories remain within the outer circles K_{O}, so that the amplifier PA is operated at near saturation or right at saturation, thus preventing nonlinearities.

In one embodiment of the invention, which is shown in FIG. 3, a device for generating quadrature components I,Q from polar components IQR is arranged upstream from the device for modifying trajectories T-MOD. Then, the quadrature components I,Q are obtained from the amplitude component A of a signal to be transmitted and the phase component Phi of the signal to be transmitted. The provision of this device IQR makes it possible to use the device T-MOD even in transmitters that do not have direct access to the quadrature components I,Q.

As an alternative to this, the device for modifying trajectories T-MOD receives the quadrature components I,Q directly, and the amplitude component A and the phase component Phi of the signal to be transmitted are obtained from a polar conversion RtP.

In one embodiment of the invention, the processing unit is an FPGA, DSP, ASIC, microcontroller, microprocessor or the like.

In another embodiment of the invention, the device is intended for use in a wireless digital transmission system, such as a 3G, LTE, 4G, WiMAX, DVB-T, DVB-H, DVB-S, DVB-S2, DMB, DAB,DAB+, or wired digital transmission system, such as an xDSL system.

In yet another embodiment of the invention, the processing unit uses two or more signal states of the received components for the calculation of the modified trajectory. Distortions are further minimized as a result.

In yet another embodiment of the invention, the modified trajectory in the region of the first and the second signal state is substantially unchanged, so that the error vector magnitude EVM is kept small, thus enabling reliable detection within the system parameters of the transmission system.

In yet another embodiment of the invention, the maximum phase change between two adjacent signal states and the minimum amplitude is limited.

According to another embodiment of the invention, the required number of signal points to be changed is determined dynamically based on the boundary conditions, so the modified trajectory lies as close as possible to the original trajectory. As a result, distortions are prevented.

According to yet another embodiment, shifting is not performed equally for the modified signal states, but preferably only those signal states are modified which are at a shorter distance from the origin, thus once again minimizing the distortion.

The invention makes it possible to minimize the bandwidth expansion of the polar conversion and/or to enable the minimum amplitude through modification of the vector trajectories from one signal state to another.

The method and the device being presented enable the precise processing of trajectories. For instance, the invention only enables processing of trajectories that have a zero crossing or of trajectories that pass close by the origin, so that even signals that correspond to constellations near the origin can be reliably detected even after modification of the trajectory.

Moreover, the invention being presented also makes it possible to consider several signals as the basis of the modification. As a result, even more stringent demands on in-band distortions and out-of-band emissions can readily be met in a way that simple methods are not capable of achieving.

What is more, the invention enables cost-effective real-time implementation either in hardware or software or a combination of hardware and software.

Furthermore, for newly-calculated signal states, it is possible to modify only those signal states that are nearer the origin in order to minimize distortions, rather than modifying all of the affected states in the same way. For this purpose, in an especially advantageous embodiment of the invention, the number of affected states is first determined in a step 500. Then the required phase change is determined for each successive pair of signal pointsstates and the required phase change divided among the two states (step 600), with the two states not being affected equally. In other words, the required phase change is distributed in a weighted manner based on the distance of the states from the origin, so that the state that lies nearer the origin experiences a greater phase change than the state that is further from the origin. The weighting can be done in different ways, such as with a linear decrease or decreasing as a function of the distance d, e.g.,

$$\frac{1}{\sqrt{d}}$$

or the like. In doing so, it should preferably be ensured at the same time that the calculated phase change is fulfilled and the distance between modified and original state is minimized. Furthermore, it can also be taken into account that the distance of the newly-calculated states from the origin is supposed to be greater than the minimum value.

1. Device for modifying trajectories (T-MOD) for use in a transmitting device of a digital transmission device, wherein the signals to be transmitted are modulated digitally and complexly, wherein a trajectory occurs with a change from a first signal state to a second signal state, comprising:
a first input (I₁; I₃) and a second input (I₂, I₄) for receiving components of a complex signal to be transmitted,
a first output (O₁) for making available an amplitude component of a modified signal to be transmitted,
second output (O₂) for making available a phase component of a modified signal to be transmitted, and
a processing unit which makes modified components available based on the received components of the signal to be transmitted, wherein trajectories that pass near the origin or touch the origin are modified such that the modified trajectory passes by the origin at a greater distance.

2. Device as set forth in claim 1, wherein the modified trajectories do not touch a nearly circular region around the origin.

3. Device as set forth in claim 1, wherein the processing unit uses one or more signal states of the received components for the calculation of the modified trajectory.

4. Device as set forth in claim 1, wherein the modified trajectory is substantially unchanged in the region of the first and the second signal state.

5. Device as set forth in claim 1, wherein the maximum phase change between two adjacent signal states as well as the minimum amplitude is limited.

6. Device as set forth in claim 5, wherein the required number of signal states is determined dynamically based on the boundary conditions, so that the modified trajectory lies as close as possible to the original trajectory.

7. Device as set forth in claim 1, wherein the quadrature components are obtained from the amplitude component of a signal to be transmitted and the phase component of the signal to be transmitted.

8. Device as set forth in claim 1, wherein quadrature components are received directly at the first and the second input (I₁, I₂; I₃, I₄) and the amplitude component and the phase component of the signal to be transmitted are obtained from a polar conversion.

9. Device as set forth in claim 1, wherein the processing unit is an FPGA, DSP, ASIC, microcontroller, microprocessor or the like.

10. Device as set forth in claim 1, wherein the device is intended for use in a wireless or wired digital transmission system.
